(19) United States
(12) Patent Application Publication
(10) Pub. No.: US 2023/0347356 A1
(43) Pub. Date: Nov. 2, 2023

(54) METHOD OF COMMINUTING FERTILIZER SLUGS IN A TWO-ROLL MILL

(71) Applicant: MASCHINENFABRIK KOPPERN GMBH CO. KG, Hattingen, Deutschland (DE)

(72) Inventors: Eggert DE WELDIGE, Velbert Langenberg (DE); Felix HEINICKE; Marcel PFIEFER, Oederan (DE); Agnes WINTER-PIETRUCK, Ratingen (DE)

(21) Appl. No.: 18/026,504

(22) PCT Filed: Nov. 9, 2021
(86) PCT No.: PCT/EP2021/081126

§ 371 Date: Mar. 15, 2023

(30) Foreign Application Priority Data
Nov. 30, 2020 (DE) 10 2020 131 638.0

(51) Int. Cl. B02C 4/08; B02C 4/44; B02C 4/30; B02C 21/00; B02C 23/12

(52) U.S. Cl. CPC B02C 4/08; B02C 4/44; B02C 4/30; B02C 21/00; B02C 23/12

(57) ABSTRACT

The invention relates to a method for comminuting fertiliser slugs or slug pieces in a two-roll mill (3) in the course of producing granular fertiliser material, wherein the two-roll mill (3) has two rotatingly driven grinding rolls, the roll surfaces of which are provided with a profiling, wherein the slug or slug pieces is/are placed on the two-roll mill (3) and comminuted into granular material in the roll nip formed between the grinding rolls, wherein the grinding rolls rotate at a circumferential speed of more than 5 m/s. This e method is characterised in that the surfaces of the grinding rolls are cooled during operation.

The invention relates to a method of comminuting fertilizer flake or flake particles in a two-roller mill when making fertilizer granules where the two-roller mill has two rotationally driven grinding rollers having respective profiled outer surfaces. The flake or flake particles being fed to the two-roller mill and granules are comminuted in the nip formed between the grinding rollers, and the grinding rollers rotate at a peripheral speed (at the roller outer surface) of more than 5 m/s. The roller may be a solid roll or have a roll core and a roll shell attached to the roll core or a jacket provided with profiling.

In addition, the invention relates to a method and a system for producing fertilizer granules from inorganic substances with compacted inorganic substances are the starting material, for example, as a fertilizer salt in a roller press to form flake, and flake or the flake particles produced from the flake are ground or comminuted to form fertilizer granules in a two-roll mill in the manner described above.

This type of production of fertilizer granules is also referred to as press granulation or compacting granulation. The starting material (inorganic substances) is pressed under high pressure in the (high-pressure) roller press and thereby compacted, so that the so-called “flake” is produced. This process step is referred to as press agglomeration. In a further step, the granulation is followed by comminution of the flake and preferably classification, for example by screening. In this case, the flake emerging from the roller press is generally not fed directly to the two-roller mill, but a precomminution is carried out by first comminuting the flake in a crusher and/or in a hammer mill to form flake particles. They are then fed to the two-roller mill, optionally after classification.

Since the inorganic substances are initially available as relatively fine-grained materials not suitable in this form for mechanical scattering on surfaces to be fertilized, fertilizer granules having defined grain sizes are produced by the pressing granulation and can be handled satisfactorily. The aim is generally to produce fertilizer granules having a grain size of between 1 mm and 5 mm.

The inorganic substance used in the context of the invention for making fertilizer granules is for example a mineral substance or substance obtained from the evaporation of salt water, for example a chloride or sulfate. Thus, it can preferably be potassium sulfate or potassium chloride.

In the processes or plants described one must choose between a roller press on the one hand and a two-roller mill on the other. In the roll press, the starting material is compacted under high pressure and at relatively low peripheral speeds of the rolls to the mass being pressed. In a further method step, the two-roller mill is used for comminuting the flake or bodies that are made by compacting the pulp for example by a roller crusher or a hammer mill. In contrast to roller presses, two-roller mills operate at a relatively high peripheral speed and the material is loosely scattered as a material curtain in the roller gap. The roller surfaces of the two-roller mill are provided with profilings, i.e. the roller surfaces are generally structured. In contrast to a crusher having a plurality of breaking elements (e.g. teeth) that act individually or in a small number on the feed material and comminute it, the comminution takes place in the case of a two-roller mill between the grinding surfaces that are fully structured without however there being a specific effect of individual comminuting elements on the granules to be comminuted. In the foreground of the invention lies the configuration as a two-roller mill that is consequently not to be replaced with a roller press and also not with a roller crusher.

The compaction of inorganic substances in a roller press is known, for example, from DE 28 24 827 B2, DE 38 02 173 [U.S. Pat. No. 4,925,382] and DE 1 758 978 [GB 1,278,130].

According to DE 28 24 827, the material is pressed into the roller nip under pressure by an auger conveyor. The material to be pressed is fed at a temperature greater than 120° C. and the pressing takes place with a high specific pressing force. The rolls rotate at a peripheral speed of 0.55 to 0.75 m/s. The roller surface is to be held at a temperature of less than 80° C. in order to avoid melting of the material on the press surface and the production of flake with a blank hard surface. This prior art expressly relates to a high-pressure roller press.

Moreover, DE 652 349 A describes a device for granulating granulatable products, in particular ammonium nitrate-containing fertilizers, consisting of two counterrotating rollers whose outer surfaces are set at a spacing from each other and carry an array of ridges that mesh with and fit complementarily between with the ridges of the other roller.

Furthermore, the two-roller mills mentioned above are known from practice that are operated at a high peripheral speed when making fertilizer granules and in which the previously produced flake is sprinkled loosely into the gap without pressure.

The grinding of cereals on corrugated or smooth rollers is also known from DE 21293. In order to avoid damage to the grain by harmful heating, the rollers are cooled.

The cooling of rolls is also described in DE 496543 that deals with the rolling of plastic and soft masses, in particular cocoa and chocolate masses, and alternatively mentions the rolling of rubber, oil paints and other oil- and fat-containing compositions. The cooling also serves to avoid damage to the processed masses. In addition, an impairment of the rolling process is to be avoided, inter alia by a hot melting of the mass onto the rollers. The processing of plastic materials likewise takes place at relatively low peripheral speeds and comparatively high pressure.

DE 635 879 A describes a roller for mills and rolling mills which is provided with cooling. In this case, however, a through flow of a coolant is dispensed with. Instead, for the purpose of the heat distribution in the roller, the cavity of the roller is filled with a liquid that is filled once, whereupon the inlet opening is tightly closed.

Finally, cooled rolls are also known in roll presses for hot briquetting or hot compacting of material that is processed with high temperatures, for example in the processing of reduced iron ores or sponge iron with temperatures above 900° C. (see, for example, DE 10 2012 106 527 [U.S. Pat. No. 10,518,268]). At such temperatures, the jackets of the rollers and in particular the pressing tools (e.g. mold cavities) attached thereto are subject to high wear. In order to limit such wear, cooling operations, for example water cooling, are generally provided.

These systems had no influence on the constructive design of two-roller mills for the comminution of fertilizers from flake or flake particles.

The object of the invention is to provide a method of the treatment of small fertilizer flake or flake particles in a two-roller mill of the type described above distinguished by improved functionality and economy.

In order to attain this object, the invention teaches in a method of the generic type for the comminution of fertilizer flake or flake in a two-roller mill when making fertilizer granules, where the surfaces of the grinding rollers are cooled during operation and consequently during comminution of the flake or flake particles.

According to the invention, cooling of the roller surfaces of the two-roller mill is thus provided when the comminution of granular material, namely fertilizer flake or flake particles that are produced beforehand by a high-pressure roller press, i.e. the (preferably hot) fertilizer flake or masses are comminuted in a two-roll mill with cooled roller surfaces. The invention is based on the surprising discovery that in such a two-roller mill, despite the low pressures in the roller gap and the high peripheral speeds of the roller surfaces and the associated very short contact times of the material with the roller surface by cooling, the invention proceeds without the material being treated adhering to the profiled roller surfaces. Despite the very short contact times, the cooling prevents caking or sticking of the salts or flake on the roller surfaces and consequently in the profilings of the rollers. Of particular importance here is the fact that the granular and preferably hot material, i.e. the flake or the precomminuted flake particles (e.g. with a size/fraction of 4 to 10 mm) are dropped as a material curtain without compaction into the roller gap, for example via a vibrating material passage above the roller gap and a following chute below the passage and that extends over the entire width of the roller. The roll width can be, for example, 1000 mm to 3000 mm, e.g. 1500 mm to 2500 mm. A typical roller width is, for example, 1800 mm to 2000 mm Above the vibrating trough or the like. The material is scattered as a material curtain into the chute arranged above the roller gap.

Furthermore, it is important that the grinding rollers are operated at a high peripheral speed, the speed of the two rollers—depending on the material to be processed—being identical or different. The speed of the two rollers is more than 5 m/s, preferably more than 6 m/s. At different speeds, more than 5 m/s, preferably more than 6 m/s, for the slower roller, the peripheral speeds can be 5 to 25 m/s, e.g. 5 to 20 m/s, preferably 7 to 15 m/s. The diameter of the grinding rollers is in a known manner from about 200 mm to 1000 mm, preferably from 400 mm to 800 mm, for example from 500 mm to 700 mm. The rotational speed (for both rollers or for the slower roller) can be from 80 to 2400 rpm, for example from 100 to 1000 rpm, preferably from 200 to 600 rpm, for example from 200 to 500 rpm. The resultant peripheral speed then results from the roller diameter and the rotational speed.

The grinding rollers are counter rotated. The nip is e.g. 0.5 to 10 mm, for example 1 to 5 mm. The roller gap can be predetermined in a structurally fixed manner. Preferably, however, the roller gap can be set variably in the specified range to a certain value. However, during operation, the roller gap is preferably fixed, so that, for example in contrast to grain packaging presses—it is not carried out with a roller gap that changes during operation.

The surface of the grinding rollers is preferably provided with fluting (as profiling) that can be formed, for example, by a multiplicity of formations in the form of grooves and ridges. These grooves and ridges can extend, for example, cover the width of the roller and can be oriented, for example, straight (parallel) or obliquely with respect to the roller axis, in a spiral or arcuate. It is also possible to use two rollers in a press with different profiling, e.g. a straight and a non-straight oriented fluting can be combined. The profiling of the grinding rollers of the two-roller mill is to be distinguished from the individual crusher elements realized in the case of roller breakers.

Preferably, the flake (or flake particles) is introduced dry into the two-roll mill, and the flake or flake particles preferably have a moisture content of maximum 1.5 wt %.

The material, i.e. the flake or the flake particles, is generally fed to the two-roller mill in a warm state, for example at a temperature of at least 100° C. The temperature is preferably 100° C. to 200° C. for example 120° C. to 150° C. Overall, the cooling according to the invention prevents the (granular and hot) material from adhering to the roller surfaces. For this purpose, the cooling can be such that the temperature of the roller surfaces does not exceed 100° C., for example 90° C., and preferably 80° C.

The cooling of the roller surfaces and for this purpose the rollers can be effected with internal cooling in that one or more cooling systems are integrated, for example, in the rollers. These cooling systems can be designed, for example, as liquid coolers that have one or more coolant passages for a cooling medium in the roller. Water, for example, can be used as the cooling medium.

According to the invention, the method is of particular importance for the treatment of fertilizer flake or flake particles in such a two-roller mill, specifically when making fertilizer granules based on inorganic substances. The invention also relates to a two-roller mill of the type described for comminuting such fertilizer flake where this two-roller mill is designed to carry out the described method and is consequently provided with cooling. The roller of such a two-roller mill can be designed as a solid roll or, on the one hand, in a manner known in principle

A roller core and a roller shell arranged on the roller core or a ring jacket is formed with the described profiling. The roller shell, which can also be formed in multiple parts from a plurality of segments, or the annular jacket can consequently be replaced as wear elements and can be detachably fastened to the roller core. Cooling is preferably realized by one or more cooling passages that are designed to cool the roller surface. For this purpose, for example, cooling passages can be formed in the roll core, in the jacket (or the roll shell) and/or between the roller core and the jacket/casing. Such passages can be introduced, for example, as bores into the roller core and/or into the jacket. One possible embodiment is characterized in that the cooling passages or an annularly circumferential or spirally circumferential cooling passage is formed between the roller core and the jacket. This can be realized structurally, for example, in that a helical circumferential annular groove is formed in the roller core on its outer surface and this groove is closed by the attached jacket and thus forms a circumferential, helical annular passage as a cooling passage on the inner side of the jacket. Alternatively, such an annular groove can also be introduced into the jacket on its inner surface. It is always expedient to feed the cooling medium into the roller body via a central or axis-parallel feed passage. From there, the cooling medium can be fed, for example via radial feed passages, into the region of the surface, for example into the spiral cooling passage.

In addition, the invention relates to a method of producing fertilizer granules from inorganic substances, where the feedstock is first compacted in a (high-pressure) roller press to form a pulp, and bodies or flake produced from the pulp are subsequently comminuted in a two-roller mill in the described manner, the rollers of the two-roller mill being cooled during comminution. In this case, the processing of granular, hot material is paramount. The starting material is preferably fed as feedstock to the roller press at a temperature of at least 100° C. Consequently, hot material is processed so that the flake or flake particles are also supplied as a preferably granular material in the hot state of the two-roller mill, preferably at a temperature of at least 100° C.

In a preferred embodiment, the flake particles that emerge from the high-pressure roller press, are not fed directly to the two-roller mill, but are first precomminuted in a precomminutor. The precomminutor can be, for example, a roll crusher and/or a hammer mill. As a result, flake or flake particles are first produced from the pulp and these are fed to the roller mill for granulation.

For this purpose, it is also advantageous if a classification of the flake particles takes place between the precomminutor and the two-roller mill, for example with one or more sieves. For this purpose, reference is made to the specific description.

Finally, the invention also relates to a plant for producing fertilizer granules according to the inventive method, where the system has at least one roller press (high-pressure roller press) and a two-roller mill. The latter is provided according to the invention with a cooling system for the roller surfaces. Preferably, at least one precomminutor and/or a classifying device are also provided. For this purpose, reference is also made by way of example to the description of the figures.

The invention will be described in the following with reference to drawings illustrating a single embodiment. In the drawing:

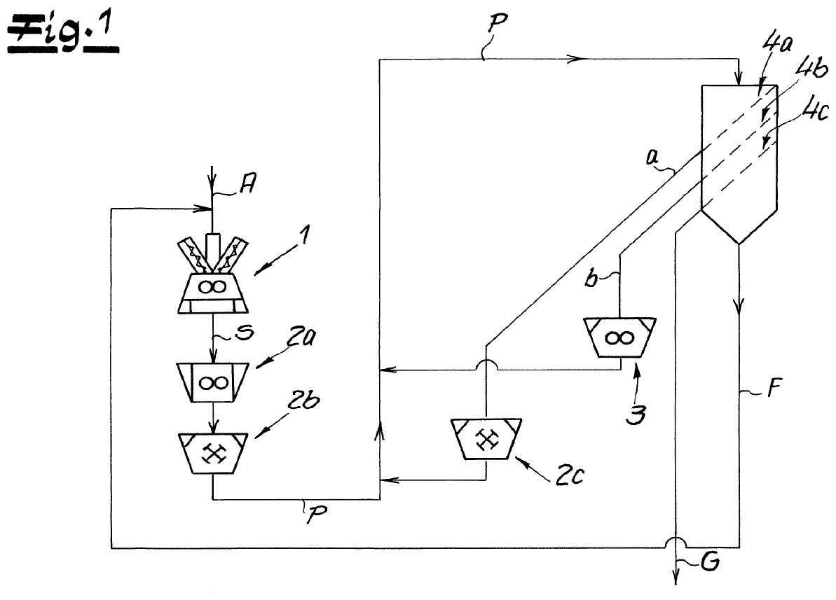

FIG. 1 is a greatly simplified flow diagram for a plant or process for making fertilizer granules from inorganic substances,

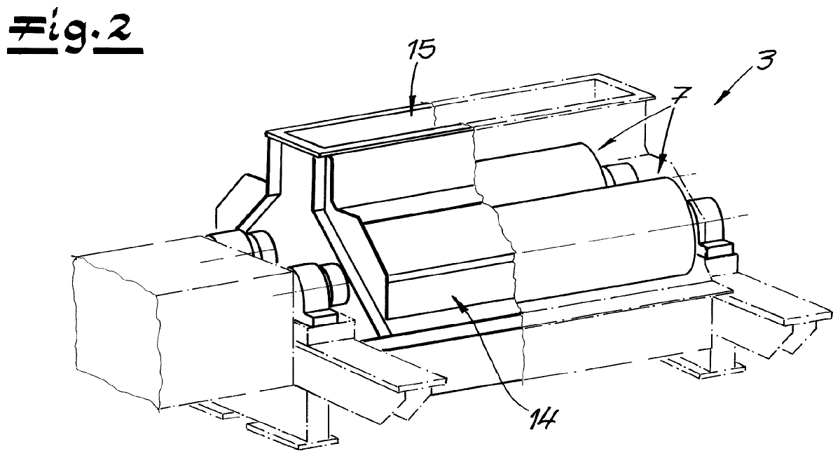

FIG. 2 is a view of a two-roller mill for the comminution of fertilizer flake according to the method, and

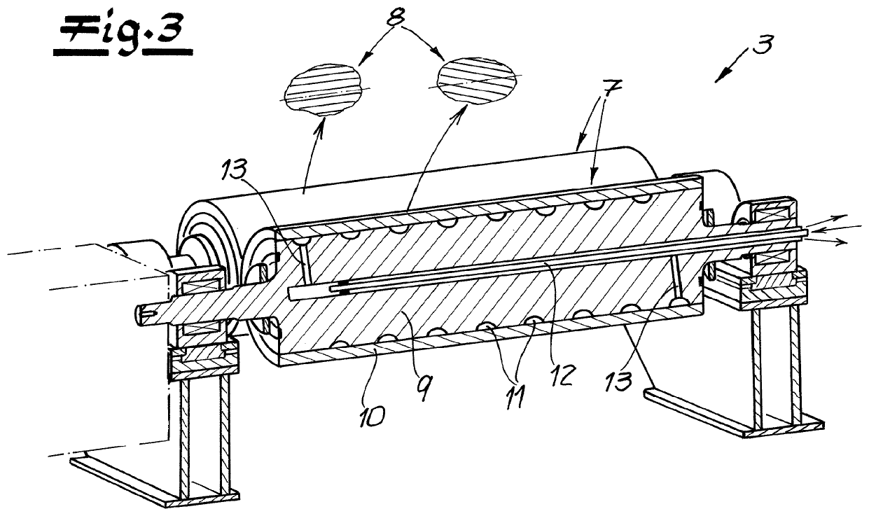

FIG. 3 is a section through the two-roller mill according to FIG. 2.

FIG. 1 shows schematically greatly simplified a plant for making fertilizer granules from inorganic substances at a temperature of, for example, at least 100° C. The plant has a high-pressure roller press 1. In this roller press 1, the starting material A, namely inorganic substances, is pressed and thereby compacted to form flake S. Subsequently, these flake S are granulated in that a precomminution is first optionally carried out in at least one precomminutor 2a, 2b. This precomminutor can be designed, for example, as a roller crusher 2a. Alternatively or additionally, it can also be a hammer mill 2b or a plurality of such devices can also be combined with one another for precomminution. In any case, granules or flake particles P are produced from the flake S in this way that are then comminuted in a next process step and consequently granulated. For this purpose, the flake particles P that have, for example, a temperature of at least 100° C. are fed to a two-roller mill 3 and comminuted in the two-roller mill to form granules G.

In the embodiment shown in FIG. 1, a classification takes place between the precomminution and the comminution and a screening device 4 with a plurality of sieve stages 4a, 4b, 4c is provided between the precomminutor 2 and the two-roller mill 3.

The flake particles P are fed to the screening device and very coarse granules having a size of more than 10 mm are screened off as the coarse fraction by the first sieve stage 4a. This coarse fraction a can be supplied, for example, to a further comminutor 2c, for example a hammer mill, and from there the comminuted granules are fed again to the screening device 4. In the second screening stage 4b, an average-size fraction b having a grain size of, for example greater than 4 mm to 10 mm, is supplied as a feed material to the two-roller mill 3 and is comminuted there in the manner described. The comminuted material is circulated and consequently fed again to the screening device 4. In the third screening stage 4c, a material having a fine grain size of 2 mm to 4 mm and consequently the desired granulate G is sieved off and discharged as product G. The finest material F passing through all the sieve passages is fed back to the compacting granulation process again and consequently the roller press 1 is reloaded for compaction.

The design and operation of the two-roller mill 3 are of particular importance in the context of the invention. In order to prevent the flake particles or granules from sticking to the roller surfaces or profiling, the roller surface is cooled. For this purpose, reference is made to FIG. 2.

FIG. 2 schematically shows a two-roller mill 3 with two counter-rotating grinding rollers 7 having respective outer surfaces provided with profilings 8 formed, for example, as complementary arrays of ridges and grooves that mesh together. These arrays axially cover the rollers and the grooves and ridges extend at an angle obliquely to the roller axis. In the illustrated embodiment, each of the rollers 7 consists of a rotatably driven roller core 9 and an annular jacket 10 mounted on the roller core and in turn provided with the profiling 8.

The rollers 7 are each equipped with a cooling system that chills the respective roller surface. For this purpose, cooling passages 11 are integrated in the rollers. In this embodiment shown, these cooling passages 11 are each designed as spiral-shaped cooling passages 11. ?Structurally, these can be realized in that the roller core 9 is provided on the outside circumferentially with an annularly circumferential spiral groove that is closed by the mounted jacket 10, so that a spiral-shaped cooling passage 11 forms between the roller core 9 and the jacket 10. In this embodiment, the cooling medium is supplied via a central feed passage 12 along the axis of the roll core. The cooling medium can be fed to and outputted from the cooling passage 11 via radial passages 13.

In addition, the drawing shows that the two-roller mill 3 is surrounded by a housing 14. Furthermore, a feed chute 15 is provided through which the material is supplied, and this chute 15 can be part of the housing or housing 14.

The material is loosely scattered into the nip like a curtain without pressure. For this purpose, a vibration feeder or vibration platform (not shown) can be provided, via which the material passes into the chute 15 above the roller gap and is guided from there into the roller gap.

According to the invention, the cooling of the described two-roller mill is of particular importance, since the cooling in this method surprisingly makes it possible to avoid clogging of the profiling or fluting. This is of essential importance, since clogging the profiling results in shearing action being reduced in the gap and thus the material is broken into finer pieces. Furthermore, the open, middle roller gap is reduced and this also results in more fine material being produced. Both are fed back again to the roller press after the next sieve passage and passes through the process again. As a result of this undesired fine material, the circulating load in the system increases and thus loss of product is reduced. Overall, clogging of the profiling consequently leads to a reduction in the efficiency and thus to a reduction in the economic efficiency of the plant. According to the invention, these disadvantages are avoided in a surprisingly simple manner by the described cooling of the rollers, specifically explicitly in a two-roller mill with the described method.

1. A method of comminuting fertilizer flake or flake particles in a two-roller mill when making fertilizer granules, where
the two-roller mill comprises two rotationally driven grinding rollers having respective outer surfaces provided with profilings,
the flake or flake particles are fed to the two-roller mill and granules are comminuted in the nip formed between the grinding rollers,
the grinding rollers rotate at a peripheral speed or with peripheral speeds of more than 5 m/s, and
the outer surfaces of the grinding rollers are cooled during operation.

2. The method according to claim 1, wherein the roller surfaces are cooled with an internal cooling of the rollers by cooling systems integrated in the rollers.

3. The method according to claim 2, wherein the cooling systems are designed as liquid cooling systems that have one or more cooling passages for a liquid cooling medium.

4. The method according to claim 1, wherein the grinding rollers rotate at a peripheral speed or with peripheral speeds of 5 to 25 m/sec.

5. The method according to claim 1, wherein the grinding rollers have diameters of 200 mm to 1000 mm, and/or rotate at a rotational speed or rotational speeds of 80 to 2400 rpm.

6. The method according to claim 1, wherein the flake or the flake particles are fed to the two-roller mill at a temperature of at least 100° C.

7. The method according to claim 1, wherein the cooling of the grinding rollers is carried out such that the temperatures of the roller surfaces do not exceed 100° C.

8. The method according to claim 1, wherein the roller gap has a gap width of 0.5 to 10 mm or is set to such a gap width in the case of a variable gap setting.

9. The method according to claim 1, wherein the surfaces of the grinding rollers have corrugations formed by a multiplicity of grooves and ridges that extend over the roller width and are oriented parallel or obliquely to the roller axis or spirally or arcuately.

10. The method according to claim 1, wherein the flake or the flake particles are scattered into the nip as a curtain of loose material.

11. A two-roller mill for comminuting fertilizer flake or flake particles, for carrying out the method according to claim 1, wherein the rollers are equipped with cooling systems for cooling the roller surfaces.

12. A method of making fertilizer granules from inorganic substances, wherein
inorganic substances in a roller press are first compacted to form flake as starting material, and
the flake particles produced from the flake are then comminuted or comminuted in a two-roller mill using a method according to claim 1.

13. The method according to claim 12, wherein the flake are precomminuted with at least one precomminutor, for example a roller crusher and/or a hammer mill, to form flake particles that are fed to the two-roller mill.

14. The method according to claim 13, wherein between the precomminutor and the two-roller mill and/or downstream of the two-roller mill the flake particles are classified, for example with one or more sieves.

15. The method according to claim 12, wherein the material is circulated in that material emerging from the two-roller mill preferably fed back to the screening device.

16. The method according to claim 12, wherein the starting material is fed to the roller press at a temperature of at least 100° C. or the flake or the flake particles are fed to the two-roller mill at a temperature of at least 100° C.

17. A system for making fertilizer granules from fertilizer salt with a method according to claim 12, with at least one roller press and at least one two-roller mill, wherein
the rollers of the two roller mill are equipped with cooling systems for cooling the roller surfaces.

18. The system according to claim 17 in the embodiment as a circulating compacting and granulating plant.
